(19) United States
(12) Patent Application Publication
(10) Pub. No.: US 2024/0208607 A1
(43) Pub. Date: Jun. 27, 2024

(54) DRIVE DEVICE FOR AN ELECTRIC BICYCLE AND ELECTRIC BICYCLE

(71) Applicant: Porsche eBike Performance GmbH, Ottobrunn (DE)

(72) Inventors: Johannes Biechele, Ottobrunn (DE); Julius Thorwart, Ottobrunn (DE)

(21) Appl. No.: 18/557,235

(22) PCT Filed: Feb. 24, 2022
(86) PCT No.: PCT/EP2022/054663

§ 371 Date: Oct. 25, 2023

(30) Foreign Application Priority Data
Apr. 27, 2021 (DE) 10 2021 110 725.3

(51) Int. Cl. B62M 6/55; B62J 45/411; B62J 45/412; B62M 11/14

(52) U.S. Cl. CPC B62M 6/55; B62J 45/411; B62J 45/412; B62M 11/145

(57) ABSTRACT

In an embodiment a drive device includes a motor unit comprising electric motor configured to drive an electric bicycle, a pedal crankshaft rotatable about an axis of rotation and a gearbox coupled on the one hand to the motor unit and on the other hand to the pedal crankshaft and is configured to output a torque for driving the electric bicycle, wherein the pedal crankshaft is a two part element having a first part element and a second part element which are coupled to one another.

### CROSS-REFERENCE TO RELATED APPLICATIONS

This patent application is a national phase filing under section 371 of PCT/EP2022/054663, filed Feb. 24, 2022, which claims the priority of German patent application 102021110725.3, filed Apr. 27, 2021, each of which is incorporated herein by reference in its entirety.

### TECHNICAL FIELD

The invention relates to a drive device for an electric bicycle and an electric bicycle having such a drive device.

### BACKGROUND

Bicycles realize low-cost, easy-to-use and emission-free means of transportation. They have also become widespread as sports or fitness equipment, and types particularly suitable for various sports applications have emerged.

In recent years, there has been growing enthusiasm for electric bicycles (especially so-called “pedelecs”), despite their high weight and price for bicycles. Potential customers are not only older cyclists who are less fit or free of sporting ambitions, but also sporty, younger riders, whether for use on the way to work or because of the possibility of using them to extend the radius of action and/or increase the speed of travel without overstraining one's own physique. Among mountain bikers in particular, interest in electrically assisted mountain bikes seems to be growing. In the case of electric bicycles, it is a challenge to provide a reliably assisting drive system that allows high power transfer.

### SUMMARY

Embodiments provide a reliable drive system for electric bicycles, which allows a particularly clear and space-saving structure.

According to one embodiment, a drive device for an electric bicycle is disclosed. The drive device comprises a motor unit having an electric motor for driving the electric bicycle. The drive device further comprises a pedal crankshaft rotatable about an axis of rotation. In addition, the drive device has a transmission gearbox which is designed for driving the electric bicycle and which is coupled on the one hand to the motor unit and on the other hand to the pedal crankshaft and which is set up to output a torque for driving the electric bicycle, the pedal crankshaft being designed in two parts and having a first part element and a separate second part element which are coupled to one another.

By means of the described drive device, a reliable drive concept for electric bicycles can be realized, which enables a particularly and space-saving structure. In particular, due to the split pedal crankshaft, a compact design with radially arrangeable motor unit and gearbox can be realized, which also enables the use of modern crank standards of pedal cranks of electric bicycles. The drive device described is particularly suitable as an electric bicycle drive system for mounting on a down tube or on a seat tube of the electric bicycle.

According to an embodiment of the drive device, the gearbox is formed as a planetary gear with a sun gear and at least one planet gear and is arranged coaxially around the pedal crankshaft with respect to its axis of rotation, so that the planetary gear coaxially surrounds the pedal crankshaft. Thus, the planetary gear can be arranged radially and in a space-saving manner. The planetary gear can be single-stage or multi-stage.

According to a further embodiment of the drive device, the motor unit is formed as a ring motor and is arranged coaxially around the pedal crankshaft with respect to the axis of rotation of the pedal crankshaft, so that the ring motor coaxially surrounds the pedal crankshaft. Thus, the ring motor can be arranged radially and in a space-saving manner.

According to a further embodiment of the drive device, the pedal crankshaft forms a bearing seat for the planetary gear and/or the ring motor. In this way, one or both components can be arranged radially and in a particularly space-saving manner, for example by coupling them to the pedal crankshaft using ball bearings and/or roller bearings.

According to a preferred embodiment of the drive device, the pedal crankshaft is narrower in a central section than in an end section, relative to the axis of rotation. For example, the pedal crankshaft has a diameter of inclusive 10-23 mm in the middle section and a diameter of inclusive 23-35 mm in the end section.

In particular, due to the two-piece design of the pedal crankshaft, the pedal crankshaft can be formed to be significantly thinner or narrower in the middle section than at the outer end sections. In addition, the pedal crankshaft can also be formed in three parts, four parts or multiple parts. The first part element and the second part element each have two end portions, one of which also forms a respective end portion and the other of which forms a respective middle portion of the pedal crankshaft. With the respective end section forming the middle section of the pedal crankshaft, the part elements are coupled to each other, for example plugged together, pressed, welded and/or screwed together. Thus, the middle section of the assembled pedal crankshaft is formed, which may be designed to be significantly narrower than the two end sections intended to be connected to pedal cranks of an electric bicycle.

With respect to the embodiments of the gearbox as a planetary gear and the motor unit as a ring motor, these components may be fitted or slid onto the narrower end portion of one or both of the part elements before the part elements are coupled together. Accordingly, a method of manufacturing the drive device may include providing and coupling the respective components. For example, the motor unit as a ring motor is slid onto a narrower end portion of the first part element and thereupon the planetary gear is also arranged radially therearound. Subsequently, a narrower end portion of the second part element may be fixedly connected to the narrower end portion of the first part element.

According to a further preferred embodiment of the drive device, the first part element and/or the second part element are formed in the shape of a sleeve at least in a coupling region, so that at least one of the two part elements extends into the other. In this case, the coupling region forms the region of the end sections of the part elements to be connected, which form a central section of the pedal crankshaft and, in particular, can be designed to be narrower than the other end sections. The partial element(s) can be of continuous or only sectional sleeve design.

According to a further preferred embodiment of the drive device, the first and second part elements are coupled to each other by means of a predetermined coupling structure which connects the two part elements to each other in a form-fit, force-fit and/or material-fit manner. Such a coupling structure may also comprise a screw element that extends along the axis of rotation into the two part elements and screws them together. Alternatively or additionally, the coupling structure may be formed such that one part element has a protruding or raised portion which is predefined in coordination with a corresponding recess on the other part element. For example, one or more pins are formed on an outer surface of the first part element, which engage in correspondingly formed recesses on an inner surface of the sleeve-shaped second part element. Thus, a reliable hold of the two part elements with each other can be realized, which can provide a certain positional specification of the two part elements, which can additionally be screwed, glued and/or welded.

According to another preferred embodiment, the drive device further comprises a speed sensor unit comprising a speed sensor and a speed disc, wherein the speed disc is coupled to the pedal crankshaft so as to be rotatable about the axis of rotation. The rotational speed disc has, for example, a spiral-shaped or a helical contour with respect to the axis of rotation, and the rotational speed sensor is arranged as a function of the contour of the rotational speed disc such that radial or axial rotational speed detection is set up with respect to the axis of rotation. The rotational speed sensor unit has, for example, a rotational speed sensor in the form of a Hall sensor, which enables a high, virtually stepless sampling rate based on the Hall effect and magnetic fields to be measured. Alternatively or additionally, the speed sensor unit can also be designed in such a way that another tachometer method can be implemented, for example by means of a magnetized speed disc.

The drive device may further comprise a motor housing in which the motor unit and the gearbox are arranged and through which the pedal crankshaft extends. The speed disc is then preferably arranged outside the motor housing with respect to the axis of rotation. Thus, for example, the motor unit and the gearbox, in particular in the design as a ring motor and planetary gear, can be placed in a particularly space-saving manner around the narrow central section of the pedal crankshaft in the motor housing. The end sections of the pedal crankshaft then extend, for example, to outside the motor housing and can, in particular, also be designed as a bearing seat for the motor housing and have edge projections or a stepped shape, which can define a predetermined position of the motor housing relative to the pedal crankshaft and also contribute to a stable and secure hold.

The speed sensor can also be arranged outside the motor housing or be located inside the motor housing and positioned in such a way that it enables reliable measurement in interaction with the externally located speed disc. The fact that the speed disc and, if applicable, also the speed sensor are positioned outside the motor housing means that access is easier and that the speed disc or speed sensor can be usefully serviced.

According to a further embodiment, the drive device has a cover which covers the speed disc and is coupled to the motor housing so that the speed disc is arranged between the cover and the motor housing. Thus, the speed disc can be reliably and safely arranged outside the motor housing and secured against undesirable external influences. The speed disc is then connected, for example, to the externally located end portion of the first part element of the pedal crankshaft and is rotatably supported between the pedal crankshaft and the motor housing with respect to a condition mounted on the electric bicycle.

The drive device may further include a torque sensor disposed outside the motor housing with respect to the axis of rotation. Further, a chainring system may be provided that is coupled to the pedal crankshaft for driving the electric bicycle, wherein the torque sensor is integrated into the chainring system. The torque sensor outside the motor housing integrated in the spider further enables a compact housing installation space and thus a particularly slim frame design, as well as beneficial serviceability of the torque sensor due to its easier accessibility. The chainring system has a plurality of chainrings or gear-shaped elements coupled together and can also be referred to by the English term “spider”. The torque sensor then monitors, in particular, a relative movement of interlocking structures of the chainring system and enables safe operation of the electric bicycle with improved riding comfort.

The described embodiments of the drive device each enable a compact, lightweight and/or inexpensive-to-manufacture electric drive system for an electric bicycle. In particular, according to an embodiment with a ring motor and a planetary gear, which are arranged coaxially around a narrow center of the pedal crankshaft, which can also act as a bearing seat, a particularly space-saving and robust design of the drive device is possible through functional integration. Preferably, a speed sensor with a speed disc is further provided, which is formed as a helix or spiral or as a multi-tooth gear and is arranged outside the housing installation space of the motor housing, so that a slim frame design of the electric bicycle can be further contributed to.

According to a further embodiment, there is disclosed an electric bicycle comprising a bicycle frame having a lower frame portion extending to a bottom bracket having a pedal crank. The electric bicycle includes a drive device according to any of the previously described embodiments disposed in or on the frame portion, such that the pedal crankshaft is coupled to the pedal crank and torque is transmittable by means of the gearbox to drive the electric bicycle. The electric bicycle substantially enables the aforementioned features, advantages, and functions.

For example, for attachment to the frame portion, the frame portion has a recess so that the drive device can be reliably received. According to one embodiment, the drive device is arranged, for example as an assembly in the already coupled state on the frame section, in particular mounted.

The drive device enables an efficient and space-saving mechanical system for assisting in cycling. This is made possible in particular by the two-part or multi-part design of the pedal crankshaft, which can thereby be formed in an inner or middle section with a significantly smaller outer diameter than at the end sections located on the outside.

### BRIEF DESCRIPTION OF THE DRAWINGS

Embodiments, advantages and functions are explained in the following description by means of embodiment examples with the aid of the attached figures. The figures show:

FIG. 1 shows a schematic view of an electric bicycle with a mounted drive device;

FIG. 2 shows a schematic sectional view of an embodiment of the drive device for the electric bicycle;

FIG. 3 shows a further schematic sectional view of components of the drive device according to FIG. 2; and

FIGS. 4-5 show schematic embodiments of a speed sensor unit of the drive device according to FIG. 2.

### DETAILED DESCRIPTION OF ILLUSTRATIVE EMBODIMENTS

Identical, similar or similarly acting elements are given the same reference signs in the figures. For reasons of clarity, not all the elements shown in all the figures are identified by the corresponding reference signs, possibly.

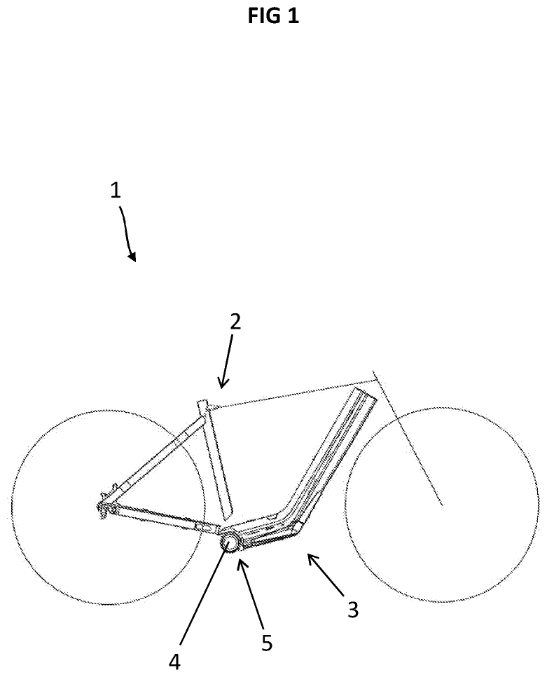

FIG. 1 schematically shows an electric bicycle 1 with a bicycle frame 2 which, among other things, has a lower frame section 3 which forms a down tube. The frame section 3 extends towards a bottom bracket, which comprises a pedal crank 4 coupled or couplable to an electric drive device 5 for the electric bicycle 1.

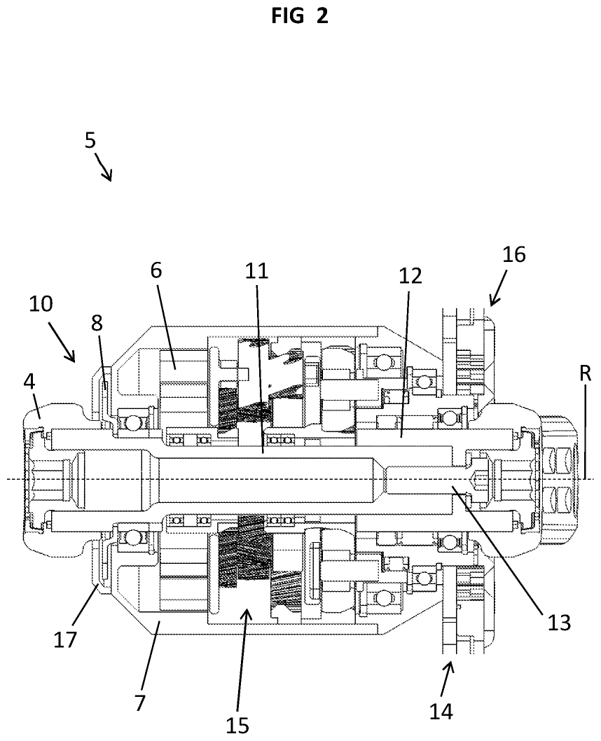

FIGS. 2-5 schematically show an embodiment of the drive device 5 or of components of the drive device 5. FIG. 2 shows a sectional view through the drive device 5, which comprises, among other things, a motor unit with an electric motor, which is designed as a ring motor 6 for driving the electric bicycle 1. The drive device 5 further comprises a pedal crankshaft, which is rotatable about an axis of rotation R and which is formed in two parts and comprises a first part element 11 and a second part element 12, which are coupled to each other.

The drive device 5 further comprises a gearbox configured as a planetary gear 15 having a sun gear and at least one planetary gear for driving the electric bicycle 1. The planetary gear 15 is coupled on the one hand to the ring motor 6 and on the other hand to the pedal crankshaft 11, 12 and is arranged to output a torque for driving the electric bicycle 1.

The planetary gear 15 and the ring motor 6 are each arranged coaxially about the pedal crankshaft 11, 12 with respect to the axis of rotation R of the pedal crankshaft 11, 12 so that they coaxially surround the pedal crankshaft 11, 12. The pedal crankshaft 11, 12 thereby forms a bearing seat for the planetary gear 15 and the ring motor 6. In particular, the fact that the pedal crankshaft 11, 12 is narrower in a middle section than at its end sections makes it possible to achieve a particularly space-saving and clear structure of the drive device 5.

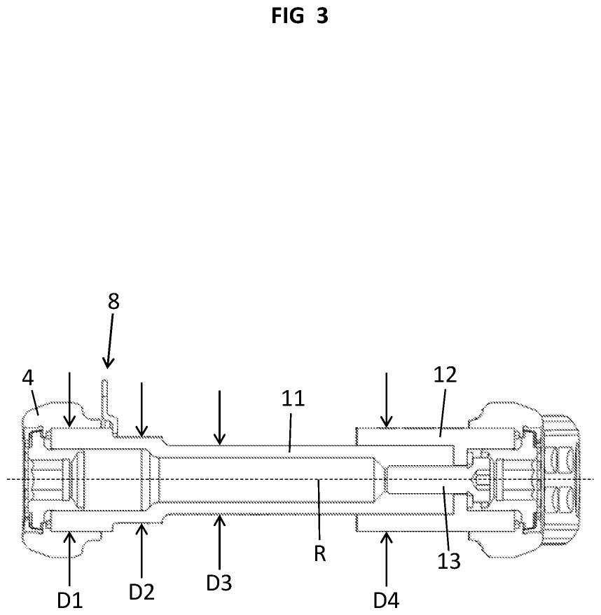

FIG. 3 shows a clearer illustration of a possible design of the two-part pedal crankshaft 11, 12 according to FIG. 2. The two part elements 11 and 12 each have two end sections, one of which faces the other part element 11, 12 and the other of which forms an outer end section of the assembled pedal crankshaft. The two outer end portions are connected to the pedal cranks 4 of the electric bicycle 1.

The first part element 11 has a significantly narrower configuration in the portion which is coupled to the second part element 12 than in its opposite end portion. For example, at the outer end portion, the first part element 11 has a diameter D1 that is larger than a diameter D2 of an inwardly oriented adjacent region. A further section of the first part element 11 adjoins this area, which has a diameter D3 that is smaller than the diameter D2. The various diameters D1-D3 are formed in a predetermined manner, in particular with regard to the arrangements of the interacting components of the drive device 5. The first part element 11 is formed in the shape of a sleeve, so that the diameters D1-D3 described refer to outer diameters of such a shaft sleeve.

The second part element 12 is also of sleeve-shaped design and has a predetermined outer diameter D4, which corresponds, for example, to the diameter D1. In the section which is coupled to the first part element 11, the second part element 12 preferably has an inner diameter which essentially corresponds to the diameter D3 of the first part element 11 and is only slightly smaller. Thus, the first part element 11 can extend into the second part element 12 and be interlocked, pressed and/or welded thereto.

For example, in the middle section, the pedal crankshaft has diameters D2 and D3 of the first part element 11, which have a value between 15-23 mm inclusive, for example. In the outer end sections, which correspond on the one hand to the area of the first part element 11 with diameter D1 and on the other hand to the area of the second part element 12 with diameter D4, the pedal crankshaft has, for example, an extension of 23-35 mm inclusive in each case.

The two part elements 11 and 12 are coupled to one another by means of a screw element 13 which extends along the axis of rotation R through the second part element 12 into the first part element 11 and screws the two part elements 11, 12 together. In this respect, the first part element 11 has a threaded section on an inner side which interacts with the screw element 13. According to such an embodiment, the second part element 12 is preferably formed as a shaft sleeve with a transverse wall which has a through opening in coordination with the screw element 13. According to the embodiment example illustrated in FIGS. 2 and 3 in sectional view, such a shaft sleeve corresponds to a letter “H” lying on its side.

Alternatively or additionally, the first and second part elements 11, 12 can be coupled to each other by means of a further coupling structure which couples the two part elements 11, 12 to each other in a form-fitting, force-fitting and/or material-fitting manner.

In addition, the drive device 5 has a speed sensor unit 10 and a torque sensor 14, each of which is arranged outside a motor housing 7. The ring motor 6 and the planetary gear 15 are arranged in the motor housing 7. The pedal crankshaft 11, 12 extends through the motor housing 7. The motor housing 7 serves to protect the ring motor 6, the planetary gear 15 and other elements interacting therewith, such as ball or roller bearings. In addition, the motor housing 7 enables reliable connection of the drive device 5 to the bicycle frame 2 or the frame section 3.

The speed sensor unit 10 comprises a speed sensor 9 and a speed disc 8, the latter being coupled to the pedal crankshaft 11, 12 so as to be rotatable about the axis of rotation R (see FIG. 2). The speed disc 8 is arranged outside the motor housing 7 between the pedal crank 4 and the motor housing 7 with respect to the axis of rotation R. The speed disc 8 is connected to the pedal crank shaft 11, 12. The speed disc 8 is connected to the pedal crankshaft 11, 12 at a predetermined position at the end portion in which the first part element 11 changes its dimension from D1 to D2. Such a transition may be oblique, angular or curved and, in particular, may be adapted to a tethering of the speed disc 8. The drive device 5 also has a cover 17 which covers the speed disc 8 and protects it from external influences. The cover 17 is coupled to the motor housing 7, so that the speed disc 8 is arranged between the cover 17 and the motor housing 7.

The torque sensor 14 is integrated into a chainring system 16 coupled to the pedal crankshaft 11, 12 for driving the electric bicycle 1 and having a plurality of chainrings or gear-shaped elements that initiate manual operation of the electric bicycle 1 and engagement of the electric drive device 5 to assist the rider of the electric bicycle 1 as needed.

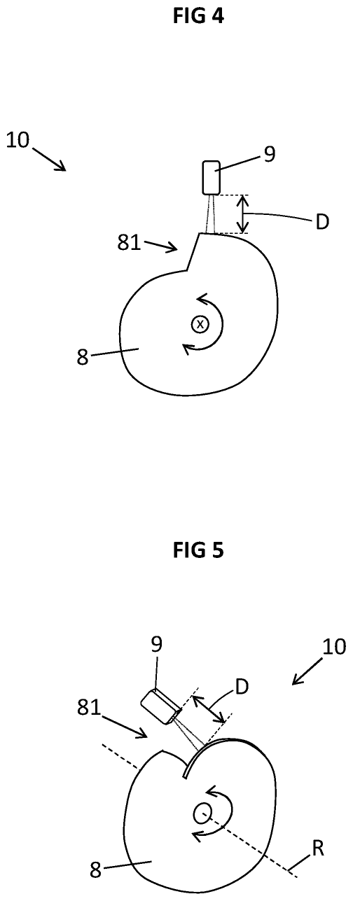

FIGS. 4 and 5 show embodiments of the speed disc 8, which may have a spiral contour (see FIG. 4) or a helical contour (see FIG. 5) with respect to the rotation axis R. The speed sensor 9, which is implemented for example as a Hall sensor, is arranged depending on the contour of the speed disc 8 in such a way that a radial speed detection (see FIG. 4) or an axial speed detection (see FIG. 5) is set up with respect to the rotation axis R. The radial speed detection is shown in FIG. 4.

Radial speed detection is illustrated schematically in FIG. 4 and is performed by measuring the distance of the rotating speed disc 8 in a direction transverse to the axis of rotation R, in particular perpendicular to it. The speed disc 8 has an edge or a step contour 81 on its circumference, which can be reliably detected by means of the speed sensor 9. A distance D between the speed sensor 9 and the contour of the speed disc 8 undergoes a step change in the area of the step contour 81. In addition, the distance D also changes continuously due to the spirally rotating contour of the speed disc 8. The distance D to be measured is thus variable.

The same applies analogously to the axial speed measurement according to FIG. 5, according to which the distance measurement of the rotating speed disc 8 is carried out in the axial direction, for example parallel to the axis of rotation R. The rotational speed disc 8 is helical or screw-like in shape, so that the distance D between the rotational speed sensor 9 and a surface of the rotational speed disc 8 facing the rotational speed sensor 9 changes. In particular, such a change is continuous until a step change is detected in the step contour 81 area. The distance D to be measured is thus also variable according to such an orientation of the speed sensor unit 10. In particular with such an axial speed detection, the speed sensor 9 can, for example, be arranged in an existing free space in the motor housing 7 and detect a rotation of the externally mounted speed disc 8. In FIG. 2, an arrangement of the speed sensor 9 is possible, for example, in the area between the ring motor 6 and the speed disc 8. The motor housing 7 can then have an opening, for example, in the direction towards the speed disc 8, which enables reliable speed measurement. In addition, the drive device 5 can also comprise two or more speed sensors 9 and speed discs 8, so that, for example, axial and radial speed measurement is possible.

By means of the described drive device 5, a reliable drive concept for electric bicycles can be realized, which enables a particularly and space-saving design. The drive device 5 is particularly suitable for mounting on a down tube or on a seat tube of the electric bicycle 1 and enables an advantageous drive system particularly with regard to a high efficiency and a small size.

1-14. (canceled)

15. A drive device comprising:
a motor unit comprising an electric motor configured to drive an electric bicycle;
a pedal crankshaft rotatable about an axis of rotation; and
a gearbox coupled to the motor unit and to the pedal crankshaft and is configured to output a torque for driving the electric bicycle,
wherein the pedal crankshaft is a two part element having a first part element and a second part element which are coupled to one another.

16. The drive device according to claim 15, wherein the gearbox is a planetary gear with a sun gear and at least one planet gear and is arranged coaxially around the pedal crankshaft with respect to the axis of rotation of the pedal crankshaft so that the planetary gear coaxially surrounds the pedal crankshaft.

17. The drive device according to claim 16, wherein the motor unit is a ring motor and is arranged coaxially around the pedal crankshaft with respect to the axis of rotation thereof so that the ring motor coaxially surrounds the pedal crankshaft.

18. The drive device according to claim 17, wherein the pedal crankshaft forms a bearing seat for the planetary gear and/or the ring motor.

19. The drive device according to claim 15, wherein the pedal crankshaft is narrower in a middle section than in an end section with respect to the axis of rotation.

20. The drive device according to claim 19, wherein the pedal crankshaft has a diameter between 15 mm and 23 mm, inclusive, in the middle section and a diameter between 23 mm and 35 mm, inclusive, in the end section.

21. The drive device according to claim 15, wherein the first part element and/or the second part element are sleeve-shaped at least in a coupling region and at least one part of the two part element extends into the other.

22. The drive device according to claim 15, wherein the first part element and the second part element are coupled to one another by a coupling structure that couples the two part element to one another in a form-fitting, force-fitting and/or material-fitting manner.

23. The drive device according to claim 15, further comprising a speed sensor unit comprising a speed sensor and a speed disc, wherein the speed disc is rotatably coupled to the pedal crankshaft about the axis of rotation.

24. The drive device according to claim 23,
wherein the speed disc has a spiral-shaped or a helical contour with respect to the axis of rotation, and
wherein the speed sensor is arranged as a function of the contour of the speed disc such that a radial or axial speed detection is set up with respect to the axis of rotation.

25. The drive device according to claim 24, further comprising a motor housing in which the motor unit and the gearbox are arranged and through which the pedal crankshaft extends, wherein the speed disc is arranged outside the motor housing with respect to the axis of rotation.

26. The drive device according to claim 25, further comprising a torque sensor arranged outside the motor housing with respect to the axis of rotation.

27. The drive device according to claim 26, further comprising a chainring system coupled to the pedal crankshaft and configured to drive the electric bicycle, wherein the torque sensor is integrated in the chainring system.

28. The drive device according to claim 15, wherein the motor unit is a ring motor and is arranged coaxially around the pedal crankshaft with respect to the axis of rotation thereof so that the ring motor coaxially surrounds the pedal crankshaft.

29. The electric bicycle comprising:
a bicycle frame with a lower frame portion extending to a bottom bracket bearing comprising a pedal crank; and
the drive device according to claim 15 coupled to the bicycle frame such that the pedal crankshaft is coupled to the pedal crank.
